(19) United States
(12) Patent Application Publication
(10) Pub. No.: US 2006/0229119 A1
(43) Pub. Date: Oct. 12, 2006

(54) Drive system for a crop conveying device

(76) Inventors: Heiner Wamhof, Bal Iburg (DE); Ferdinand Hellenbrand, Thyrnau (DE)

Correspondence Address: STRIKER, STRIKER & STENBY, 103 EAST NECK ROAD, HUNTINGTON, NY, 11743, US

(21) Appl. No.: 11/402,069

(22) Filed: Apr. 11, 2006

(30) Foreign Application Priority Data
Apr. 12, 2005 (DE) 10 2005 016 950.3

(51) Int. Cl. A01F 12/32

(52) U.S. Cl. 460/101

(57) ABSTRACT

In a method and a device for driving a crop conveying unit composed substantially of at least one pan with at least one sieve the pen and receive are hung in an oscillation-facilitating manner in a machine housing, at least one oscillation-reducing drive unit is provided, drive unit is formed by a linearly-oscillation unit, and the drive unit is controlled via a change in a parameter selected from the group consisting of frequency, stroke, and both.

### BACKGROUND OF THE INVENTION

The present invention relates to the field of processing harvested crops in general.

Self-propelled agricultural machines designed to pick up and process crops, e.g., corn or different types of grain, are used for this purpose. The self-propelled agricultural machines are typically threshing machines, in particular combine harvesters, which are equipped with devices for processing the crop material. To process the crop material, which is composed of a mixture of grain material and non-grain components, devices are used, e.g., to separate the different components of the crop material. A device of this type is, e.g., a crop conveying device, which is composed of a fan unit, a conveyance device, a return device and a cleaning unit with an upper sieve and a lower sieve located in a sieve pan, the crop conveying unit including a drive unit.

With a combine harvester of this type, the harvested crop material is directed by the feed device to the threshing unit, in which the mixture is separated. The threshed straw is subsequently directed via a tray-type shaker with a plurality of steep steps to the back end of the combine harvester. The mixture of grain portions and non-grain portions, e.g., grain, and chaff and non-threshed ears, removed from the crop material via the threshing procedure in the region of the threshing drum and the upstream acceleration cylinder travels via the grain separating device to the grain pan, from where the mixture is directed to the cleaning unit, which is usually composed of a plurality of sieves, the upper sieve and sieve pan—with the lower sieve located therein—being movably supported.

The trays of the shaker located downstream of the cylinder and set into an oscillating motion via crankshafts remove a further mixture from the crop material, the further mixture also being composed of a grain portion and a non-grain portion. To remove the further mixture from the crop material, the trays of the shaker use the “Multifinger—Separator System”, residual-grain removal system effectively located downstream of the threshing system. The removed mixture is also directed to the cleaning unit via the movably supported return device, which is composed of the return pan and its drive.

Both mixtures, from the grain separating device and the tray-type shaker, therefore reach the upper sieve via the respective pan. Via the upper sieve, the crop material reaches the lower sieve located beneath it and, once it has passed through the lower sieve, is transported via a conveyor, e.g., an auger, to the grain tank.

A fan unit with a plurality of air ducts is typically located in front of the cleaning unit, which is set into an oscillating motion using a suitable shaking device. The fan unit is used to separate the grain-chaff mixture and other impurities from each other before the chaff and short-straw portion are blown out or ejected through the back end of the sieve. This means, the mixture is separated many times as it travels from its grain separating device via the grain pan, and from the tray-type shaker via the return pan to the conveyor auger, to separate the grain from the non-grain components. The mixture is separated using two different methods. The compressed air produced by the turbine fan is directed through the two sieves, which are located one on top of the other.

The two sieves, therefore, are a duplicately-ventilated straw walker step for the crop material, by way of which intensive, two-staged cleaning takes place. As a result of the two-staged cleaning, the lightweight parts composed of non-grain components are blown by the compressed air through the sieve and are discarded. An air duct directs the air flow produced by the turbine fan under the lower sieve, the next air duct directs the air flow under the upper sieve, as described above, and a further air duct directs the air flow between the sieve pan and/or the upper sieve and the grain pan and the return pan to separate the mixture, by way of which an initial separation of grain and non-grain components and relief of the upper sieve takes place.

To increase the cleaning effect and separate the mixture, the crop conveying device and its individual units, e.g., the grain pan, return pan, upper sieve and sieve pan equipped with a lower sieve, are set into an oscillating motion. The units which have been set into an oscillating motion influence the moving behavior of the mixture to be cleaned and separated.

To this end, the devices are movably supported, and all of them are connected via the same eccentric drive, and are driven and/or set into an oscillating motion by a mechanical gearbox, as made known in the related art in DE 33 32 763 C2.

The disadvantage of this cleaning unit is that it cannot be adapted to the different harvesting conditions, and the only thing available for all crops to be processed is a consistent air flow and a consistent oscillation frequency for the individual components of the crop conveying unit for conveying and separating grains and non-grain components.

The disadvantage of the consistent air flow for the cleaning unit was eliminated by the control and regulating system for blowers described in DE 198 07 145 C2, to better separate grains and non-grain components. The disadvantage—described above—of the drive that is responsible for the oscillation of the crop conveying unit still exists.

The disadvantage of the single-axis oscillation of the cleaning unit and/or its individual units in the direction of conveyance is supplemented with an additional oscillation at the sieve level of the cleaning unit, thereby resulting in an improvement of the separating process of the grains and non-grain components. To this end, a further oscillation drive is provided, according to DE 199 08 696 C1, which also acts on the cleaning unit via a mechanical coupling system. The conventional oscillation drive can also produce, via an angle drive provided in addition, an additional oscillation of the cleaning unit that extends transversely to the direction of conveyance of the crop material. The disadvantage in this case as well is that the oscillation frequency of the cleaning unit in the direction of conveyance of the crop material is constant and not variable, and it cannot be adapted to the different harvesting conditions.

### SUMMARY OF THE INVENTION

The present invention is therefore based on the object of creating a drive system for a crop conveying unit of the type described initially that prevents the aforementioned disadvantages of the known related art, and to provide a technical solution that makes it possible to manufacture a crop conveying unit having a simple functional geometry.

In keeping with these objects and with others which will become apparent hereinafter, one feature of the present invention resides, briefly stated, in a a method for driving a crop conveying unit composed substantially of at least one pan with at least one sieve, comprising the steps of hanging the pen and the sieve in an oscillation-facilitating manner in a machine housing; providing at least one oscillation-reducing drive unit; forming the drive unit by a linearly-oscillation unit; and controlling the drive unit via a change in a parameter selected from the group consisting of frequency, stroke, and both.

The crop conveying unit used to separate crop material in a self-propelled agricultural machine is a complex and technologically advanced device. The crop material, which is guided by various devices in the cleaning unit via oscillating pans, is also separated further on oscillating sieves through which air is blown to intensively loosen the mixtures, to improve grain separation. To ensure good grain separation, even when working on a hillside, the cleaning unit is designed such that the cleaning unit automatically imitates the tilted position or, in another embodiment, the cleaning mixture is evenly distributed again on the upper sieve using an oscillation drive extending transversely to the upper sieve.

In addition, the cleaning unit is equipped with sensors that make it possible, in a regulator and control circuit, to monitor the mixture in the tailings, for example, and, based on the measured result, to change the upper and lower sieve width and the flow of air through the cleaning unit. The single-axis oscillation excitation of the crop conveying unit carried out to convey the mixture is constant for all units used, because only one drive is available for all units.

Due to the requirements to retrieve fruits from the field harvested in the gentlest manner possible and cleaned and ready for market, it is provided according to the present invention to create a novel drive system for improving the separating effect for the cleaning unit in combine harvesters.

In terms of processing the crop material, the task of the crop conveying unit is to improve the separating process, i.e., to increase the portion of clean fruit and reduce the non-usable portion. To reduce the non-usable portions in the crop material, it is provided according to the present invention to equip the crop conveying units and their individual devices, such as the grain and return pans, upper and lower sieve, with their own drives and thereby independently excite the particular unit to perform a precise oscillation adapted to the particular harvesting conditions. The excitation to oscillation influences the moving behavior of the mixture to be cleaned on the particular pan and particular sieves of the crop conveying unit in the combine harvester.

The moving behavior of the crop material should be defined primarily by sliding and throwing phases in the direction of conveyance. To influence these sliding and throwing phases, it is provided according to the present invention, in order to obtain optimum conveyance and separating conditions for the mixture, to equip the individual units with a plurality of drives arranged such that excitation of oscillation takes place in a multivariant manner. Due to the degree of freedom, motion is induced in spacial coordinates X, Y, Z in the horizontal, vertical and circular directions. All directions of motion are realizable, in principle, e.g., motion can be induced in unilateral, bilateral and parallel directions, in the horizontal and/or vertical direction, and any combinations thereof. Variable motion in three planes is therefore attained for a device in the crop conveying unit.

To produce the variable motion of a device, it is provided according to the present invention to use linearly-oscillating oscillation units. The linearly-oscillating oscillation units can be designed as electrical, hydraulic or electromagnetic oscillation drives. Linearly-oscillating oscillation drives are characterized by maximum dynamics, high acceleration capacity, high end speed and excellent static and dynamic stiffness under load. Due to their compact design and resultant small spacial requirement, as well as high reliability and service life, these oscillation drives are best suited for replacing the mechanical crank drive with coupling linkage and angle drive.

The further, decisive advantage of this embodiment according to the present invention is that the oscillation units can be operated with an individual frequency, an individual stroke, and an individual force.

This will be explained below with reference to an exemplary embodiment.

The new drive system installed on the device of the upper sieve shall be described as a representative for all oscillatory-driven devices in the crop conveying unit, to depict the diverse possibilities of the cleaning process by inducing oscillations of the upper sieve in a combine harvester. For example, three oscillation units are located on the device of the upper sieve, one coordinate X, Y and Z being assigned to each oscillation unit. For the X, Y coordinates of the direction of motion, the oscillation units are located in parallel. For the Z direction of motion, they are located perpendicularly to the surface of the upper sieve, by way of which force is also introduced parallel and perpendicularly to the excited surface, the coordinates of the X direction corresponding to the direction of motion of the crop material in the direction of conveyance, the coordinates of the Y direction corresponding to the direction of motion of the crop material transversely to the direction of conveyance, and the coordinates of the Z direction corresponding to the direction of conveyance of the crop material in the vertical direction.

If only the two oscillation units located in the direction of the X and Z axis are operated simultaneously, the superimposition of the two frequencies result, at first approximation, in a sinusoidal mode of oscillation for the conveyance of the crop material on the upper sieve. The moving behavior of the crop material on the upper sieve of the cleaning unit corresponds to the formation of sliding and throwing phases. The sliding phase is characterized by the oscillation unit responsible for the X direction of motion, and the throwing phase is characterized by the oscillation unit responsible for the Z direction of motion. This is relevant because optimium separating conditions of the mixture exist when a planar oscillation motion of the individual layers of the mixture to be cleaned takes place during the sliding phase, and a high degree of loosening via throwing takes place in the throwing phase.

The further object on which the present invention is based is to vary the sliding and throwing phases individually to better respond to the different harvesting conditions and crop qualities that result from current modern agricultural methods. In modern agriculture, the straw to be harvested, for example, is still green, moist and tender. As a result, despite the APS threshing system, foreign particles from the grain separating device reach the grain pan along with the grain. In optimum sliding and throwing phases, this mixture of grain and non-grain components should be directed to the upper sieve of the cleaning unit. The grain remaining in the straw downstream of the threshing system is separated on the downstream tray-type shaker using the effective MSS system, i.e., a cylinder with controlled tines. Here as well, grain and foreign particles are discarded due to difficult harvesting conditions, such as moist straw and/or green growth. This mixture reaches the return pan and is also directed to the upper sieve via sliding and throwing phases.

The mixture from the grain separating device of the threshing system and the mixture from the grain separating device of the tray-type shaker differ in terms of the composition of grains and non-grain components. This means, mixture “A” from the threshing system has a different and higher portion of grain and a smaller portion of non-grain components than mixture “B” from the shaker. To optimize the sliding and throwing phase, it is therefore obvious that the grain pan with the “A” mixture on it should be operated with a different oscillation than the return pan with the “B” mixture. The situation for mixture “C” is even more extreme, in which the admixtures, such as straw pieces, chaff and ear portions from mixtures “A” and “B” were already reduced. The admixtures were reduced in the first straw walker step, in which mixture “A” and “B” coming from the pans is blown with an air flow produced by the cleaning fan and subsequently falls onto the upper sieve. Mixture “C” on the upper sieve therefore differs from mixtures “A” and “B” from the upstream devices by the fact that the quantity of the non-grain components in the crop material was reduced further, and the grain portions have increased. To be cleaned further, this special mixture must be loosened considerably, and air must be blown through the relatively clean, pure material. A flow of air directed from below and toward the rear is blown through the pure material; it blows out the foreign particles still remaining in the mixture to be cleaned. The oscillating upper sieve intensively loosens the grains, which have a specific weight.

To set the optimum oscillation of the upper sieve and the optimum sliding and throwing phase for the mixture to be cleaned on the upper sieve, the components of the crop material located in the tailings are automatically monitored by a tailings-measurement unit—via sensors—located at the upper end of the tailings elevator. The data acquired by the sensors is directed to an arithmetic unit and compared with the data stored in a data base, the data taking into account various harvesting conditions and crops used to compute the setting parameters for the oscillation units located on the crop conveying unit, i.e., the upper sieve in this case. If the actual value determined deviates from the stored setpoint value, the setting parameter that resulted, e.g., in the smallest amount of tailings, is selected for the responsible oscillation unit and set via the control unit. Other parameters in the measurement can be taken into account in the evaluation of the setting parameters.

Depending on which of the setting parameters is affected, the oscillation unit located in the X direction, the Y direction or the Z direction can be addressed automatically using the control unit, each oscillation unit having two possible settings due to the separation—according to the present invention—of the parameters “frequency” and “stroke”, which were previously coupled. The first setting possibility for changing the sliding and throwing phase involves changing the frequency and/or the mark-to-space ratio. The change primarily affects the throwing phase of the crop material. With the second setting possibility, the stroke and/or the travel of the oscillating oscillation is determined. The change primarily affects the sliding phase of the crop material. Using a simple winding with an iron core and a magnet, the maximum stroke of the oscillation unit results from the half of the distance between the north and south pole produced via alternating current. The stroke can be many centimeters or just a few tenths of a millimeter long. In an extreme case, to allow rapid braking of the oscillating upper sieve, for example, with the mass of crop material located on it, it is provided according to the present invention to use an eddy current brake on the upper sieve.

With another embodiment of oscillation unit, composed of a linear guide, linear motor and fastening means, the linear unit can also be acted upon with a changeable frequency and/or stroke using a digital servo adjustment. With the change in frequency and stroke, an individual setting of the parameter for the sliding and throwing phase of the mixture to be cleaned is available for every individual oscillation unit. In special situations, a change in the setting parameter for the oscillation units can be carried out manually by the operator, by switching off the automatic mode on the electronic control terminal. A control field is then available to the operator of the combine harvester by the fact that the parameters of frequency and stroke can be changed individually due to the very good automatic controller action of every individual oscillation unit. The manually set values are displayed on the monitor and can be compared with the values of the working results. The particles in the mixture to be cleaned can therefore be moved in all directions on the upper sieve. The operator is therefore given a means that enables him to make an adjustment to the preset parameters which is tailored to the working situation.

Further advantages that result from the individual setting of the oscillation units are that a “carpet” of mixture to be cleaned is prevented from forming on the upper sieve and a higher working output is obtained with an improved separation effect, combined with a simultaneous reduction in crop-material loss.

With an embodiment of drive systems of this type, the crop conveying unit can be quickly and easily adapted to the different workable crop materials and crop-material properties to obtain a good working result, e.g., when changing fields or crops, and, secondly, it can react quickly and easily to the different crop conditions that occur, by setting the optimum parameter for the crop material to be separated, thereby resulting in an increase of the crop-material portion.

In addition, with the oscillation unit located transversely to the direction of conveyance of the crop material to be cleaned, a linearly-oscillating drive is available with which the crop material can continue to be distributed evenly on the upper sieve, even when working on a hillside and with full throughput, and the mixture to be cleaned can be prevented from sliding in the downhill direction. The conveyance of the crop material, even if the pans and sieves are tilting due to a change in the ground contour in the direction of travel of the combine harvester, can be ensured via the change in frequency and/or stroke of the linearly-oscillating oscillation units located on the pans and sieves. The drive parameters of the oscillating linear oscillation units can therefore be regulated as a function of the tilt of the combine harvester, and as a function of the losses due to cleaning, the cleaning, or a preselected or manual setting.

In a further advantageous embodiment of the present invention, using the linear units, which are located perpendicularly to the upper sieve, the position of the pans and sieves relative to the tilt can be compensated for by the displacement travel of the linear units.

The upper sieve, and all devices in the crop conveying device, can be equipped with the novel drive system, as described above. To this end, the conveying elements, such as the grain and return pans, and the cleaning elements, such as the upper and lower sieves, can be elastically suspended using springs, gas or oil-pressure shock absorbers, ball-jointed bars or via electrically or hydraulically or electromagnetically adjustable linear units in the machine housing.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematized side view of a self-propelled agricultural machine,

FIG. 2 shows a layout, according to the present invention, with a plurality of linearly-oscillating oscillation units located on a freely swinging upper sieve,

FIG. 3 shows a drive system, according to the present invention, with a plurality of linearly-oscillating oscillation units composed of a linear motor with a linear guide located on the upper sieve,

FIG. 4 shows the layout, according to the present invention, for controlling the linearly-oscillating oscillation units.

### DESCRIPTION OF THE PREFERRED EMBODIMENTS

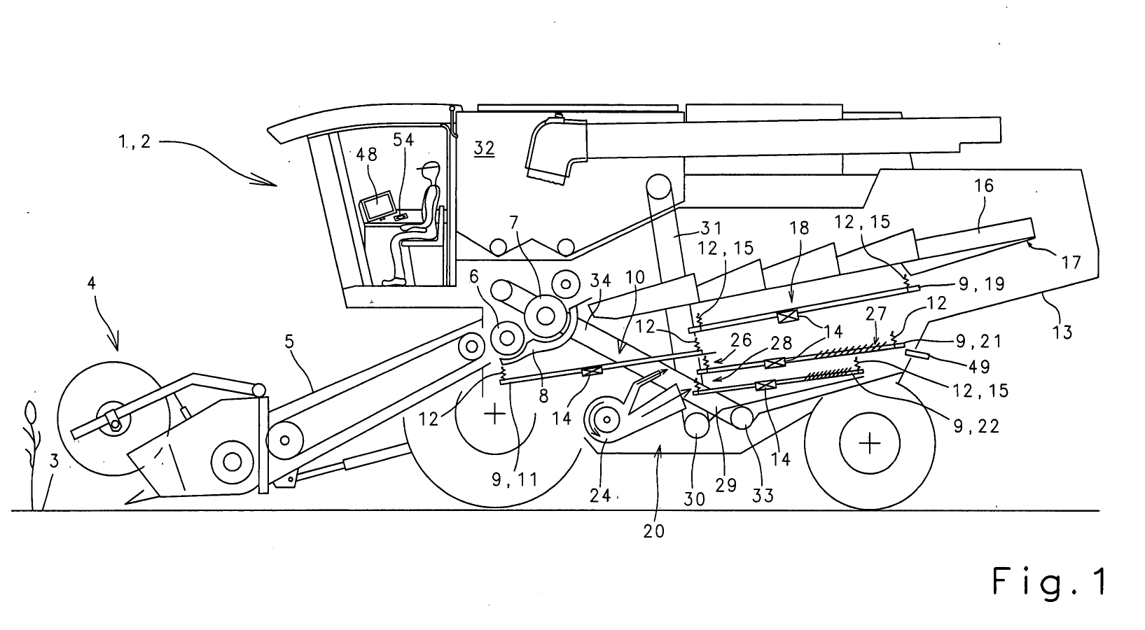

FIG. 1 shows a schematized side view of a combine harvester 2, combine harvester 2 including a method and device used to drive a crop conveying device 9 composed mainly of at least one pan 11 and at least one sieve 21, the pan 11 and sieve 21 each being hung in an oscillation-facilitating manner in machine housing 13, and at least one oscillation-inducing drive unit 14, drive unit 14 being formed by a linearly-oscillating swinging unit 14 and being controlled via a change in frequency and/or stroke.

The object of a combine harvester 2 is to pick up the crop material from a field 3 and separate it into grain and non-grain components. A header 4 and a conveyor 5 are provided for picking up and processing the crop material, conveyor 5 directing the crop material to threshing unit 6, 7. The initial separation of the grain from the ears and straw takes place in thresing unit 6, 7. The grains pass through concave 8 to the grain pan of crop conveying unit 9, crop conveying unit 9 being composed of pans 11,19 and cleaning unit 20. According to the present invention, the grain pan is a conveyance device 10 composed of a grain pan 11, which is suspended on elastic elements 15, e.g., springs 12, in an oscillating manner in machine housing 13, and on which at least one linearly-oscillating oscillation unit 14 is located for conveying the crop material further to cleaning unit 20.

The straw delivered by threshing unit 6,7 is subjected to a second separation on downstream shaker 16, the non-grain components and straw being directed to back end 17 of combine harvester 2. The grains separated in shaker 16 reach return pan device 18, which is composed of a return pan 19, which is suspended on elastic elements 15, e.g., springs 12, in an oscillating manner in machine housing 13, and on which at least one linearly-oscillating oscillation unit 14 is located for conveying the crop material further to cleaning unit 20. The crop material located on grain pan 11 and return pan 19 is directed to downstream cleaning unit 20 via an oscillating motion induced by linearly-oscillating oscillation units 14 located on pans 11,19. Cleaning unit 20 is composed of an upper sieve 21, a lower sieve 22 located in a sieve pan 23 (not shown), and a cleaning fan 24. Upper sieve 21 and lower sieve 22 are designed as chaffers. The crop material is transferred to upper sieve 21 by a straw walker step 26 ventilated by cleaning fan 24. Via the air flow in straw walker step 26, large and lightweight non-grain components are captured before they reach upper sieve 21, and they are ejected out of the back end of combine harvester 2. The smaller and heavier crop-material components fall out of upper sieve 21.

Upper and lower sieve 21, 22 are also acted upon by an air flow produced by cleaning fan 24, sieves 21, 22—similar to pans 11,19—also being suspended on springs 12 in an oscillating manner in machine housing 13 and being equipped with at least one linearly-oscillating oscillation unit 14 so that it oscillates. The oscillating motion of sieves 21, 22 and the air flow from cleaning fan 24 cause the grain and non-grain components to be directed toward the back end of upper sieve 21. Depending on the setting of upper screen width 27, the individual grains and further components of the crop material fall through upper sieve 21 of ventilated straw walker step 11 28, lightweight non-grain components being separated again at the back end of lower sieve 22 into tailings 29. Lower sieve 22 typically has a finer plate structure than upper sieve 21, and is normally operated with a smaller opening width than upper sieve 21.

Larger and lighter-weight crop-material components such as grains with husks, ear parts or stalk parts—if they have passed the first and second straw walker step 26, 28—are conveyed into tailings 29 via the oscillations of lower sieve 22 generated especially by linearly-oscillating oscillation units 14, and the air flow. The cleaned crop material itself falls directly through lower sieve 22 and is conveyed to grain tank 32 using a feed auger 30 and grain elevator 31. The crop material that reaches tailings 29 is directed via a further feed auger 33 and tailings elevator 34 of threshing unit 6, 7 to the working units of the combine harvester, to be put through another pass.

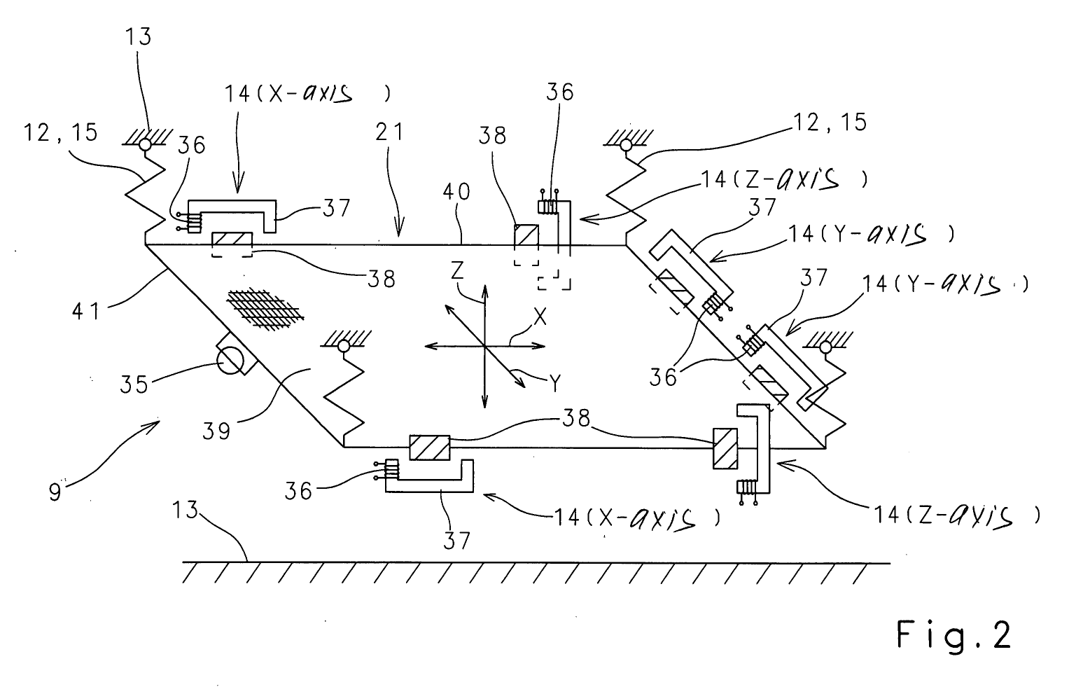

FIG. 2 shows a layout, according to the present invention, of a device, e.g., an upper sieve 21, used to drive a crop conveying unit 9 for self-propelled agricultural machines 1.

The linearly-oscillating oscillation unit 14 is formed by a winding 36 with an iron core 37 and a magnet 38, winding 36 and the iron core 37 being located on machine housing 13, and magnet 38 being located on pan 11, 19 and/or sieve 21, 22. It is also feasible for winding 36 and iron core 37 to be located on pan 11,19 and/or sieve 21, 22, and for magnet 38 to be located on machine housing 13. Pan 11, 19 suspended on elastic elements 15, e.g., springs, in an oscillating manner, and/or sieve 21, 22 can move in a freely swinging manner between the magnetic field produced by linearly-oscillating oscillation units 14, it being possible to also provide elastic elements 15 underneath pan 11,19 and/or sieve 21, 22 to fix pan 11, 19 and/or sieve 21, 22 in position. It is also feasible to use elastic elements 15 underneath and above pan 11,19 and/or sieve 21, 22.

The linear motion, e.g., of upper sieve 21, in the X direction takes place via two oscillation units 15 extending parallel to upper surface 39 and assigned to longitudinal side 40 of sieve 21. The placement of oscillation units 14 in the X direction of motion induces conveyance and ensures the sliding phase of the crop material in the direction of conveyance. The linear motion of sieve 21 in the Z direction takes place via two oscillation units 14 extending perpendicularly to surface 39 and also located on longitudinal side 40, it being possible to also locate oscillation units 14 for the Z direction on transverse side 41 of sieve 21. The excitation of sieve units 21, 22 in the Z direction of motion causes loosening and ensures the throwing phase of the crop material in the direction of conveyance. With oscillation units 14 assigned to the Z direction, a longitudinal tilt of sieve 21 can also be compensated for when working on a hillside.

The linear motion of sieve 21 in the Y direction is carried out by two oscillation units 14 located parallel to surface 39 and on transverse side 41 of sieve 21. The placement of oscillation units 14 in the Y direction of motion influences the sliding and throwing phases of the crop material, which result from the linearly-oscillating oscillation units 14 in the X and Z directions of motion. Due to the superimposition of the various oscillations, the direction of conveyance of the crop material is retained even when sieve 21 tilts to the side (lateral inclination) when working on a hillside. As a result, when a plurality of oscillation units is assigned to pan 11,19 and/or sieve 21, 22, the crop material can move in every predetermined direction of conveyance on pan 11, 19 and/or sieve 21, 22. An eddy current brake 35 located on pan 11,19 and/or sieve 21, 22 acts as a safety element in case of an unusual oscillation that could occur when combine harvester 2 is used for harvesting. This drive system according to FIG. 2 is based on a freely-oscillating crop conveying unit 9.

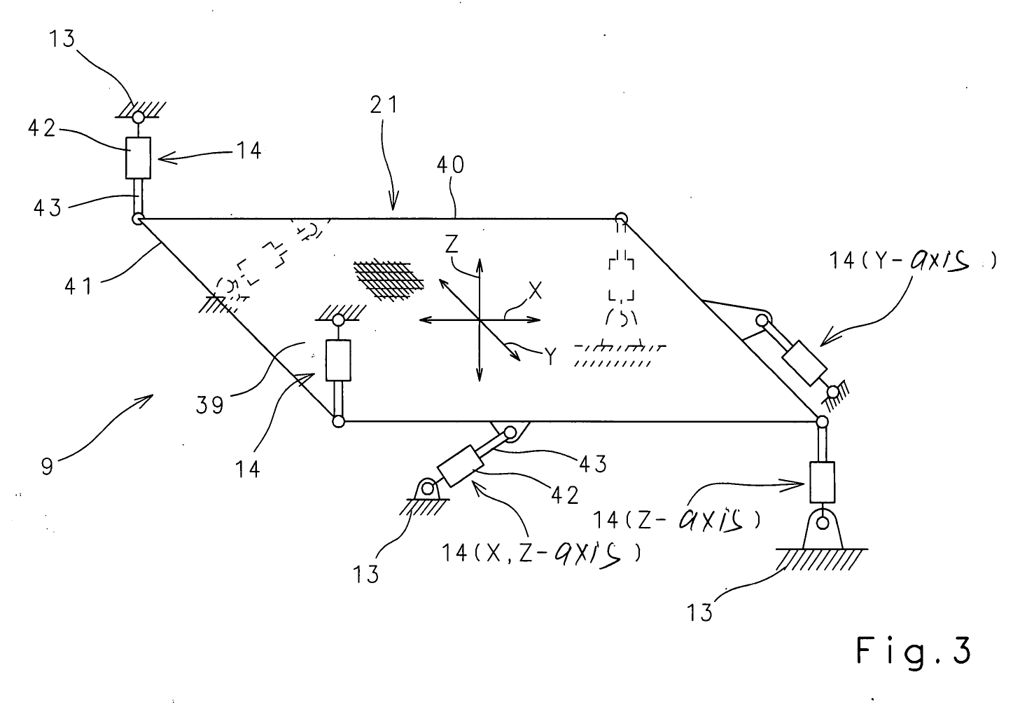

FIG. 3 shows a drive system according to the present invention with a plurality of linearly-oscillating oscillation units 14 located on upper sieve 21, composed of a linear motor 42 with linear guide 43, this being a device as recited in claim 18. Linear motor 42 with linear guide 43 can be located, individually or in pairs, parallel to surface 39 of pan 11,19 and/or sieve 21, 22. By locating the oscillation units in pairs and in parallel with the surface, an opposing excitation of oscillation of pan 11,19 and/or sieve 21,22 can also be produced, which influences the direction of the sliding phase of the crop material. Linear motor 42 with linear guide 43 can be located, individually or in pairs, perpendicularly to surface 39 of pan 11,19 and/or sieve 21, 22. By way of this placement, an opposing excitation of oscillation of pan 11,19 and/or sieve 21,22 can also be produced, this placement influencing the direction of the throwing phase of the crop material.

If linear motor 42 with linear guide 43 is located, individually or in pairs, at an angle to surface 39 of pan 11,19 and/or sieve 21, 22, oscillation of pan 11,19 and/or sieve 21, 22 is induced in the X and Z directions simultaneously. A design of this type causes the crop material to be conveyed in a sliding and throwing phase. If linear motor 42 with linear guide 43—as shown in FIG. 3—is used instead of elastic elements 15 to suspend pan 11,19 and/or sieve 21, 22, the tilt of combine harvester 2 can be compensated for by oscillation units 14 when working on a hillside, in both the longitudinal and transverse directions. Using the drive design described above, it is possible to induce motion unilaterally, bilaterally, in parallel and horizontally, and any combinations thereof. Any directions of motion and circular motions for the particles of crop material on pan 11,19 and sieve 21, 22 are realizable, in principle. The drive system shown in FIG. 3 differs from the drive system shown in FIG. 2 by the fact that oscillation units 14 according to FIG. 3 are a mechanically-coupled drive system located between machine housing 13 and devices 10,18 of crop conveying unit 9.

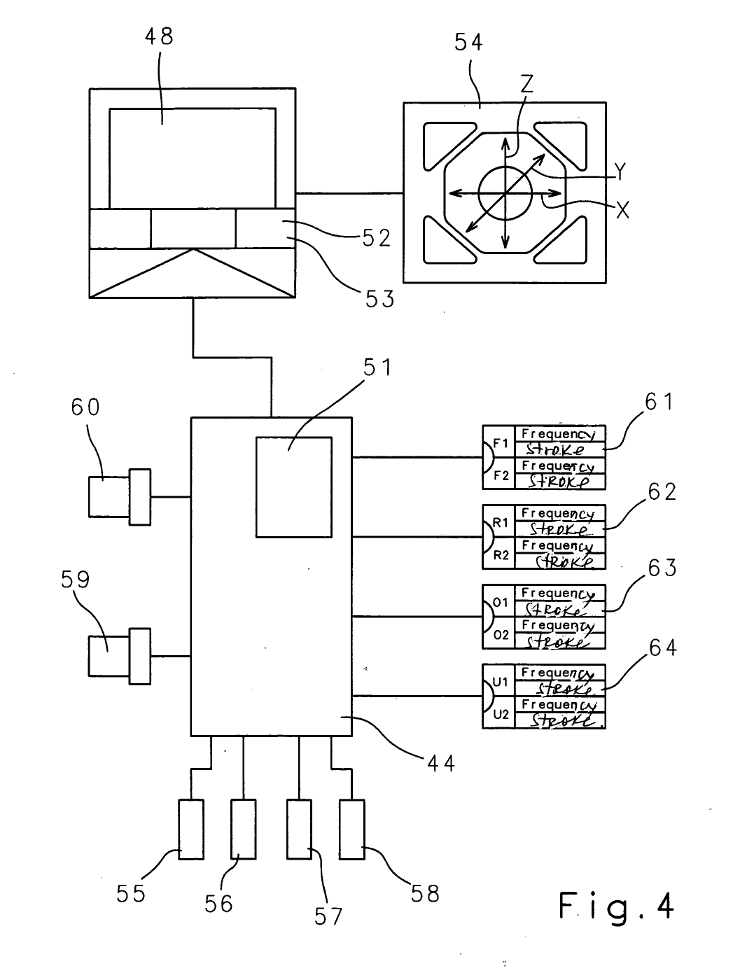

In FIG. 4, a control method for oscillation unit 14 is shown with reference to a schematic representation, the method realizing the change in frequency and/or stroke of oscillation unit 14 formed by a linearly-oscillating drive unit via a control unit 44. The control of frequency F and stroke H of linearly-oscillating oscillation unit 14 induces a change in the oscillation of crop conveying unit 9 and, therefore, a change in the sliding and throwing phase of the crop material.

A simultaneous control of frequency F and stroke H of linearly-oscillating oscillation units 14 located perpendicularly and horizontally to surface 39 of crop conveying unit 9 induces a superimposition of the oscillations on crop conveying unit 9, which results in another sliding and throwing phase for the crop material on crop conveying unit 9. The control of oscillation units 14 can become necessary based on the evaluation of working results 46. Working results 46 from the individual units of combine harvester 2 are acquired in a manner known per se and are depicted in display field 47 of monitor 48. The acquisition of working results 46 of crop conveying unit 9 is carried out using loss-measuring units 49 located on pans 11,19 and sieves 21, 22. Loss-measuring units 49 contain known sensors 50. For example, the data acquired by grain pan sensor 55, return pan sensor 56, upper sieve sensor 57, lower sieve sensor 58, and tailings 59 and yield sensor 60 are made available to memory unit 51 contained in control unit 44 for comparison with the stored data.

Loss values 53 acquired in this manner are displayed visually in a loss display 52 of monitor 48. If an acquired result deviates from predetermined loss value 53, control unit 44 automatically adjusts oscillation units 14 by controlling frequency F and/or stroke H. At this point, the operator of combine harvester 2 can use a control field 54 to manually change the setting parameters for frequency F and/or stroke H of grain pan oscillation unit 61, return pan oscillation unit 62, upper sieve oscillation unit 63 and lower sieve oscillation unit 64 using control unit 44. With this drive system according to the present invention, the operator is provided with a means that allows him to individually control individual devices 10, 18 of the crop conveying unit, such as crop conveying unit 9 and/or return and grain pans 10, 18, and to therefore adapt them to the harvesting conditions in an optimum manner.

It is within the scope of the ability of one skilled in the art to modify the exemplary embodiments described in a manner not presented, or to use them in other machines to achieve the effects described, without leaving the framework of the invention.

It will be understood that each of the elements described above, or two or more together, may also find a useful application in other types of methods and constructions differing from the types described above.

While the invention has been illustrated and described as embodied in a drive system for a crop conveying device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for driving a crop conveying unit composed substantially of at least one pan with at least one sieve, comprising the steps of hanging the pen and the sieve in an oscillation-facilitating manner in a machine housing; providing at least one oscillation-reducing drive unit; forming the drive unit by a linearly-oscillation unit; and controlling the drive unit via a change in a parameter selected from the group consisting of frequency, stroke, and both.

2. A method as defined in claim 1, wherein said controlling of the frequency of the linearly-oscillating oscillation unit includes a change in an oscillation of the crop conveying unit and therefore a change in a sliding and throwing phase of crop material.

3. A method as defined in claim 1, wherein said controlling of the stroke of the linearly-oscillating oscillation unit includes changing in an oscillation of the crop conveying unit and therefore a change in a sliding and throwing phase of a crop material.

4. A method as defined in claim 1; and further comprising locating the oscillation unit perpendicularly to a surface of the crop conveying device.

5. A method as defined in claim 1, wherein said controlling the change in said parameter from the group consisting of the frequency, the stroke, and both of the linearly-oscillating oscillation unit include automatically providing said controlling by a control unit via evaluation of loss values.

6. A method as defined in claim 1, wherein said controlling the change of the parameters selected from the group consisting of the frequency, the stroke, and both of the linearly-oscillating oscillation unit includes controlling manually by an operator, using a control field, via evaluation of loss values.

7. A device for driving a crop conveying unit for self-propelled agricultural machines, comprising substantially at least one pan with at least one sieve, said pan and said sieve being hung in an oscillation-facilitating manner in a machine housing; and at least one oscillation-inducing oscillating unit assigned to an element selected from the group consisting, said at least one pan which freely oscillates, said at least one sieve which freely oscillates, and both.

8. A device as defined in claim 7, wherein said linearly-oscillating oscillation unit is formed by a winding with an iron core and a magnet.

9. A device as defined in claim 8; and further comprising a machine housing accommodating said winding and said iron core; and a magnet located on an element selected from the group consisting of said pan, said sleeve, and both.

10. A device as defined in claim 8, wherein said winding and said iron core are located on an element selected from the group consisting of said pan, said sieve, and both, said magnet being located on said machine housing.

11. A device as defined in claim 7, wherein said linearly-oscillating oscillation unit induces an oscillation of said pan hung on an element selected from the group consisting of elastic elements, said sieve, and both in at least one direction of motion.

12. A device as defined in claim 7; and further comprising means for oscillating of an element selected from the group consisting of said pan, said sieve, and both, in X, Y and Z directions.

13. A device as defined in claim 7; and further comprising a plurality of said linearly-oscillating oscillation units assigned to an element selected from the group consisting of said pan, said sieve, and both.

14. A device as defined in claim 7; wherein the plurality of said linearly-oscillating oscillation units are arranged on said element selected from the group consisting of said pan, said sieve and both so that the crop material moves in every predetermined direction of motion in an element selected from the group consisting of said pan, said sieve, and both.

15. A device as defined in claim 14, wherein said linearly-oscillating oscillation units are located parallel to a surface of an element selected from the group consisting of said pan, said sieve, and both.

16. A device as defined in claim 14, wherein said linearly-oscillating unit are located perpendicularly to a surface of an element selected from the group consisting of said pan, said sieve, and both.

17. A device as defined in claim 7, wherein said at least one oscillation-inducing oscillation unit is formed as a linearly-oscillating oscillation drive unit located in an orientation selected from the group consisting of being located singly, being located in pairs, being located at an angle to a surface of said pan and said sieve.

18. A device as defined in claim 9, wherein said linearly-oscillating oscillation drive unit is configured as a linear motor with a linear guide.

19. A device as defined in claim 7, wherein said linearly-oscillating oscillation drive unit with an element selected from the group consisting of said pan, said sieve, and both is configured so as to serve as an elastic suspension.

20. A device as defined in claim 7, wherein said linearly-oscillating oscillation drive unit is configured to compensate for a tilt of an element selected from the group consisting of said pan, said sieve, and both, that occurs when a self-propelled agricultural machine is on a hillside.

21. A device as defined in claim 7, wherein said crop conveying unit includes a cleaning unit.

22. A device as defined in claim 7, wherein said crop conveying unit includes a return pan and a drain pan.
